(19) United States
(12) Patent Application Publication
(10) Pub. No.: US 2025/0003438 A1
(43) Pub. Date: Jan. 2, 2025

(54) Furniture Assembly

(71) Applicant: LEYO HOLDINGS SDN BHD, BATU PAHAT (MY)

(72) Inventor: Teck Lai NG, JOHOR BAHRU (MY)

(21) Appl. No.: 18/829,188

(22) Filed: Sep. 9, 2024

Related U.S. Application Data
(63) Continuation-in-part of application No. 18/434,380, filed on Feb. 6, 2024.
(63) Continuation-in-part of application No. 18/227,516, filed on Jul. 28, 2023.
(60) Provisional application No. 63/678,488, filed on Aug. 1, 2024.

(30) Foreign Application Priority Data
Dec. 15, 2003 (MY) PI2023007659
Oct. 17, 2022 (MY) PI2022005769

(51) Int. Cl. F16B 12/12; F16B 5/00

(52) U.S. Cl. CPC F16B 12/125; F16B 5/0004

(57) ABSTRACT

A furniture assembly includes a plurality of main panels interconnected to each other via a first fastening mechanism and a second fastening mechanism. The first fastening mechanism includes one or more pinholes on at least one of the main panels and one or more pins extended from at least one of the main panels to engage with, and being inserted in, the complementary pinholes. The second fastening mechanism includes one or more groove channels on at least one of the main panels and one or more projecting tongue profiles extended from at least one of the main panels to engage with, and being inserted in, the complementary groove channels. The furniture assembly remains entirely in a laying position during the assembly of the main panels.

### CROSS-REFERENCE TO RELATED APPLICATIONS

This application is a continuation-in-part of U.S. patent application Ser. No. 18/227,516, filed Jul. 28, 2023, and of U.S. patent application Ser. No. 18/434,380, filed Feb. 6, 2024. U.S. patent application Ser. No. 18/227,516 claims priority to Malaysian Patent Application No. PI2022005769, filed Oct. 17, 2022, and U.S. patent application Ser. No. 18/434,380 claims priority to Malaysian Patent Application No. PI2023007659, filed Dec. 15, 2023. This application also claims priority to, and the benefit of, U.S. Provisional Patent Application No. 63/678,488, filed Aug. 1, 2024.

### TECHNICAL FIELD

The present invention relates to a furniture assembly. More particularly, the invention relates to a furniture assembly having a plurality of panels firmly interconnected to each other via multiple fastening mechanisms.

### BACKGROUND ART

Cabinet furniture is an integral part of our homes and workplaces, providing functional storage and adding aesthetic appeal to our living spaces. Such furniture are designed to hold various items to ensure our belongings are organized and easy to accessible. Cabinets come in a variety of shapes, sizes, and styles, catering to different needs and preferences. One of the key aspects of cabinet furniture construction is the method used to connect different panels together. Two of the most commons methods are tongue and groove joints and dowel pins. Tongue and groove joints involve the interlocking of two pieces with complementary protrusions and grooves whereas the dowel pins are cylindrical rods which can be inserted into pre-drilled holes in adjoining panels.

An example of knockdown furniture assembly employing the aforementioned two methods is shown in United States Patent Publication No. US20130071172A1. The patent reveals a composed element consisting of two or more panel-shaped elements. Each of these elements features a coupling zone containing coupling parts shaped as profiled parts that extend longitudinally along the coupling zone. These profiled parts facilitate the secure interconnection of the panel-shaped elements, both in a locking manner and at an angle. Additionally, the composed element incorporates auxiliary means designed to aid in the accurate assembly of the panel-shaped elements. One limitation of the disclosed composed furniture element is that the groove is shaped in such a way that the tongue can only be inserted with a fixed initial orientation. There is no tolerance for the tongue to be inserted in another orientation. As a result, if the initial orientations are not aligned, then the tongue or the groove can be damaged during assembly. Furthermore, this patent lacks supporting panels to hold the panels in their intended orientation during the assembly of the furniture, so that the subsequent panel can be installed in an efficient manner.

Accordingly, it would be desirable to provide a furniture assembly with improved fastening mechanisms to prevent damage to the components of furniture assembly during assembly. The proposed invention provides such a furniture assembly that solves the abovementioned problems.

### BRIEF SUMMARY

In one aspect of the invention, there is provided a furniture assembly comprises a plurality of main panels interconnected to each other via a first fastening mechanism and a second fastening mechanism; wherein the first fastening mechanism includes one or more pinholes on at least one of the main panels and one or more pins extended from at least one of the main panels to engage with, and being inserted in, the complementary pinholes; wherein the second fastening mechanism includes one or more groove channels on at least one of the main panels and one or more projecting tongue profiles extended from at least one of the main panels to engage with, and being inserted in, the complementary groove channels; and wherein the furniture assembly remains entirely in a laying position during the assembly of the main panels.

Preferably, the main panels may include: a rear panel having a plurality of pinholes of the first fastening mechanism; a pair of side panels, each having a first edge with a plurality of pins of the first fastening mechanism configured to engage and insert into the pinholes of the rear panel, and a second edge, adjacent to the first edge, with a projecting tongue profile of the second fastening mechanism; and a top panel having a plurality of groove channels of the second fastening mechanism configured to engage and slidably receive the projecting tongue profiles of the side panels.

Preferably, each side panel may further comprise a third edge, opposing to the first edge, with a plurality of pins of the first fastening mechanism, and a second supporting members having a plurality of pinholes of the first fastening mechanism configured to engage and receive the pins on the third edge of the side panels.

Preferably, the rear panel may be a foldable panel, whereby the foldable panel comprises a pair of board bodies hinged by a flexible strip, allowing the board bodies to flap between a folded configuration and an expanded configuration.

Preferably, the main panels further may include a centre panel with the same configuration as the side panels.

Preferably, at least one groove channel of the second fastening mechanism may include a first section and a second section, whereby the first section, has a cross-sectional area wider than the second section, is configured to initially receive one portion of the projecting tongue profile with a wider tolerance of insertion angles than the second section and to subsequently guide the projecting tongue profile to slide towards the second section at a designated orientation.

Preferably, at least one of the projecting tongue profile may have a dovetail tongue configuration, the second section can be a dovetail groove configuration that are complimentary to the dovetail tongue configuration, and the first second can be a square groove configuration.

Preferably, each pin of the first fastening mechanism may include a first portion and a second portion, both of which have serrated circular protrusions, the diameter of the serrated circular protrusions on the first portion can be larger than those on the second portion.

Preferably, a third fastening mechanism can be provided for attachment of at least one first supporting panel to the main panels, whereby the third fastening mechanism includes at least one first attachment member attached to at least one of the main panels, and a tongue profile extended from the at least one first supporting panel, the first attachment member includes a groove profile that is complementary to the tongue profile so that the tongue profile can engage with and being inserted into the complementary groove profile. Preferably, the groove profile may include a closed end for preventing the first supporting panel from overextending while the tongue profile is sliding within the groove profile.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a perspective view diagram illustrating a rear panel of a first embodiment the furniture assembly.

FIG. 2 is a perspective view diagram illustrating an installation of a first side panel of the furniture assembly to the rear panel.

FIG. 3 is a perspective view diagram illustrating an installation of a second supporting panel to the side panels and a centre panel.

FIG. 4 is a perspective view diagram illustrating an installation of a top panel to the assembly.

FIG. 5 is a perspective view diagram illustrating a second embodiment a furniture assembly.

FIG. 6 is a perspective view diagram illustrating a rear panel of the furniture assembly.

FIG. 7 is a perspective view diagram illustrating an installation of a first side panel of the furniture assembly to the rear panel.

FIG. 8 is a perspective view diagram illustrating an exemplary of a pin for connecting the main panels.

FIG. 9 is a perspective view diagram illustrating an installation of a centre panel of the furniture assembly to the rear panel.

FIG. 10 is a perspective view diagram illustrating an installation of a second side panel of the furniture assembly to the rear panel.

FIG. 11 is a perspective view diagram illustrating an installation of a first supporting panel to the side panels and the centre panel.

FIG. 12 is a perspective view diagram illustrating a first attachment member.

FIG. 13 is a perspective view diagram illustrating an assembly of a second supporting panel.

FIG. 14 is a perspective view diagram illustrating an installation of the second supporting panel to the side panels and the centre panel.

FIG. 15 is a perspective view diagram illustrating an installation of a top panel to the assembly.

FIG. 16 is a schematic diagram illustrating a groove channel with two profiles.

FIG. 17 is a perspective view diagram illustrating a re-orientation of the assembly.

FIG. 18 is a perspective view diagram illustrating a stopper member.

FIG. 19 is a perspective view diagram illustrating a front panel and an installation of a first side panel of a drawer unit.

FIG. 20 is a schematic diagram illustrating a groove on the front panel with two profiles.

FIG. 21 is a perspective view diagram illustrating an installation of a second side panel of the drawer unit to the front panel.

FIG. 22 is a perspective view diagram illustrating an installation of a supporting panel of the drawer unit to the front panel.

FIG. 23 is a perspective view diagram illustrating an installation of a base panel of the drawer unit to the drawer assembly.

FIG. 24 is a perspective view diagram illustrating an installation of a rear panel of the drawer unit to the drawer assembly.

### DETAILED DESCRIPTION

Embodiments of the invention will now be described in greater detail, by way of example, with reference to the drawings.

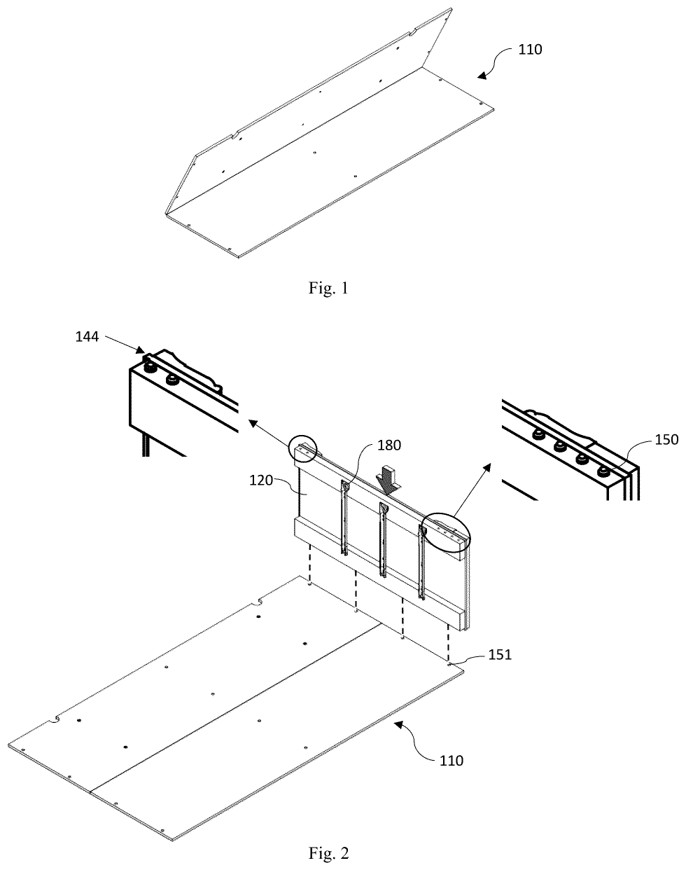

Referring to FIGS. 1 to 4, a first embodiment of a furniture assembly 100 is illustrated. In general, a furniture assembly 100 is formed by a plurality of main panels 110, 120, 130, 140 that are interconnected to each other via a first fastening mechanism and a second fastening mechanism. Preferably, the furniture assembly 100 is a multiple column cabinet featuring a plurality of sliding drawer units 200. More specifically, it may adopt the style of a Louis Philippe cabinet. Nevertheless, it should be understood that the furniture assembly 100 is not limited to such configuration and it can also takes the form of other type of furniture such as a rack, a shelf, cupboard, and so forth. Preferably, the main panels 110, 120, 130, 140 include a rear panel 110, a pair of side panels 120, a centre panel 130, and a top panel 140. The main panels 110, 120, 130, 140 may be made of various wood materials, such as, but not limited to, particleboards, medium-density fiberboards, plywoods, solid woods, hardboard, melamine, veneered woods, and laminate. In the first embodiment of the furniture assembly 100, the structural integrity and aesthetic appearance of the furniture assembly 100 can be further enhanced by at least one second supporting member 171.

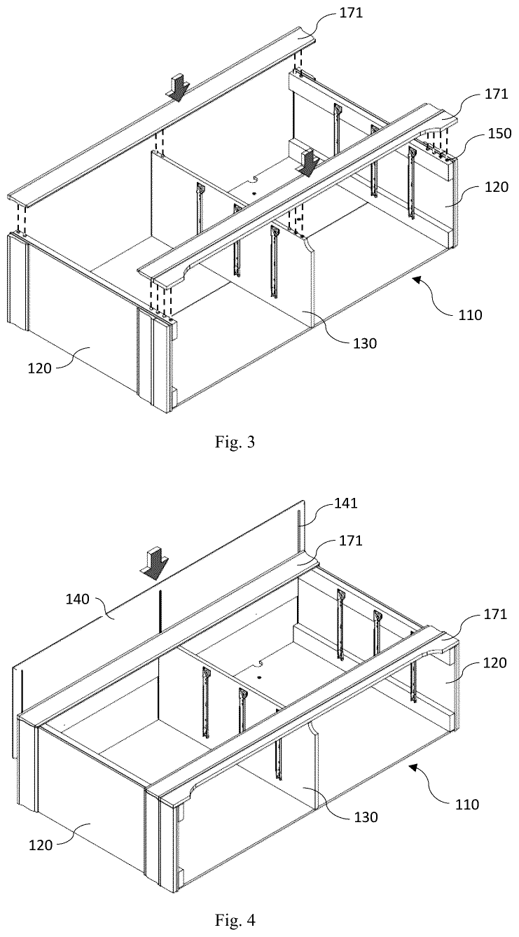

FIG. 1 illustrates an exemplary of the rear panel 110 of the first embodiment of the furniture assembly 100. Preferably, the rear panel 110 is designed to be foldable. FIG. 2 illustrates an exemplary of a first side panel 120 attaching onto the rear panel 110. A plurality of attachment members are provided on one side of a first side panel 120. The attachment members include a plurality of drawer sliding tracks 180. Preferably, the first side panel 120 is attached to the rear panel 110 via the first fastening mechanism. Specifically, the first fastening mechanism includes a plurality of prefabricated pinholes 151 on edges of the rear panel 110 and one or more pins 150 extended from an edge of the first side panel 120. The pinholes 151 and the pins 150 are positioned in such a way that they will be aligned with one another when the first side panel 120 is attached to the rear panel 110. Preferably, at least one portion of the pins 150 is pre-inserted into the edge of the first side panel 120. The second side panel 120 and the centre panel 130 share the same configuration as the first side panel 120, and they are attachable to the rear panel 110 via the first fastening mechanism. FIG. 3 illustrates the second supporting member 171 being attached to the pair of side panels 120 and the centre panel 130 via the first fastening mechanism.

FIG. 4 illustrates an exemplary of the top panel 140 attaching to the assembly. Preferably, the top panel 140 is attached to the assembly via the second fastening mechanism. Specifically, the second fastening mechanism includes one or more groove channels 141 on the top panels 140 and one or more projecting tongue profiles 144 extended from the side panels 120 and the centre panel 130 to engage with, and being inserted in, the complementary groove channels 141 via a sliding movement. In one specific embodiment, the pair of side panels 120 and/or the centre panel 130 each having a first edge with the plurality of pins 150 of the first fastening mechanism configured to engage and insert into the pinholes 151 of the rear panel 110, a second edge, adjacent to the first edge, with the projecting tongue profile 144 of the second fastening mechanism, and a third edge, opposing to the first edge, with the plurality of pins 150 of the first fastening mechanism for engaging with the pinholes 151 of the second supporting member 171. Up to this stage, the furniture assembly 100 remains entirely in a laying position during the assembly of the main panels 110, 120, 130, 140. The furniture assembly 100 will then be re-orientated after the attachment of the top panel 140 to an operational configuration from the laying position. When the assembly is in its operational configuration, it is also ready to receive the drawers units 200.

Referring to FIG. 5, a second embodiment of the furniture assembly 100 as illustrated. In general, the furniture assembly 100 is formed by a plurality of main panels 110, 120, 130, 140 that are interconnected to each other via a first fastening mechanism and a second fastening mechanism. Preferably, the furniture assembly 100 is a multiple column cabinet featuring a plurality of sliding drawer units 200. More specifically, it may adopt the style of a Louis Philippe cabinet. Nevertheless, it should be understood that the furniture assembly 100 is not limited to such configuration and it can also takes the form of other type of furniture such as a rack, a shelf, cupboard, and so forth. Preferably, the main panels 110, 120, 130, 140 include a rear panel 110, a pair of side panels 120, a centre panel 130, and a top panel 140. The main panels 110, 120, 130, 140 may be made of various wood materials, such as, but not limited to, particleboards, medium-density fiberboards, plywoods, solid woods, hardboard, melamine, veneered woods, and laminate. The structural integrity and aesthetic appearance of the furniture assembly 100 can also be further enhanced by at least one first supporting member 161 and at least one second supporting member 171.

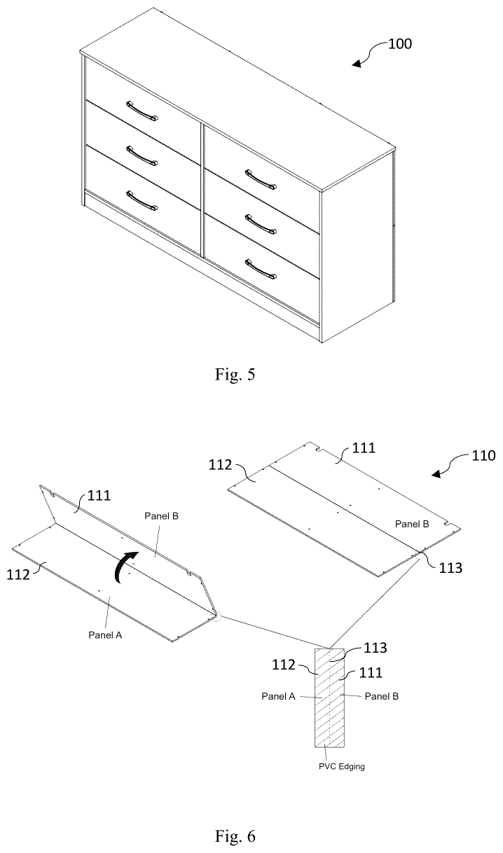

FIG. 6 illustrates an exemplary of the rear panel 110. Preferably, the rear panel 110 is designed to be foldable. The foldable panel can be formed by connecting longitudinal sides of two board bodies 111, 112 through a flexible strip 113. This configuration enables the board bodies 111, 112 to pivot between a folded configuration and an expanded configuration. The flexible strip 113 may be constructed from polyvinyl chloride material which is commonly employed in edging applications. In the initial stage of the assemble process, the rear panel 110 is pivoted to its expanded configuration so that it is ready to receive other panels.

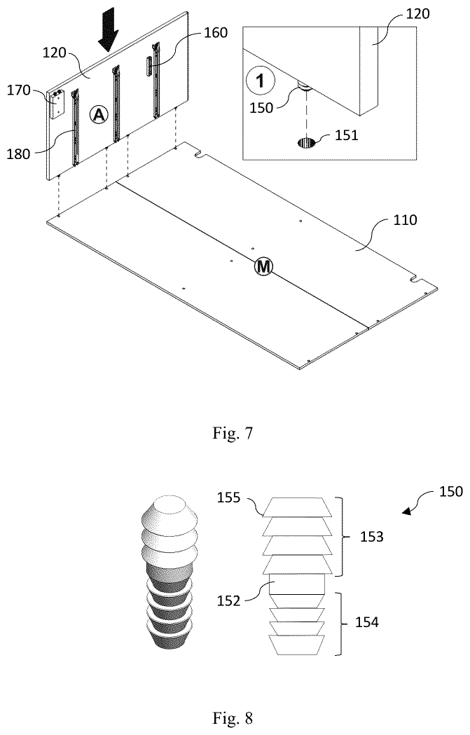

FIG. 7 illustrates an exemplary of a first side panel 120 attaching onto the rear panel 110. A plurality of attachment members are provided on one side of a first side panel 120. The attachment members include at least one first attachment member 160, at least one second attachment member 170 and a plurality of drawer sliding tracks 180. Preferably, the first side panel 120 is attached to the rear panel 110 via the first fastening mechanism. Specifically, the first fastening mechanism includes a plurality of prefabricated pinholes 151 on edges of the rear panel 110 and one or more pins 150 extended from an edge of the first side panel 120. The pinholes 151 and the pins 150 are positioned in such a way that they will be aligned with one another when the first side panel 120 is attached to the rear panel 110. Preferably, at least one portion of the pins 150 is pre-inserted into the edge of the first side panel 120.

One specific embodiment of the pin 150 is shown in FIG. 8. The pin 150 may comprise a cylindrical body 152 having a first portion 153 and a second portion 154, both with serrated circular protrusions 155 that can grip onto the inner surface of the pinholes 151 upon insertion. Preferably, the diameter of the serrated circular protrusion 155 on the first portion 153 is larger than those on the second portion 154. This configuration allows the second portion 154 to be inserted into prefabricated pinholes 151 on the edges of the side panel 120, and the larger serrated circular protrusions 155 on the first portion 153 act as a stopper to prevent the first portion 153 from being inserted into the pinholes 151. In this embodiment, the pinholes 151 at the side panel 120 are sized to be slightly smaller or about the same as the second portion 154 so that the second portion 154 can be fittably inserted into the pinholes 151. Likewise, the pinholes 151 at the rear panel 110 are also sized to be slightly smaller or about the same as the first portion 153.

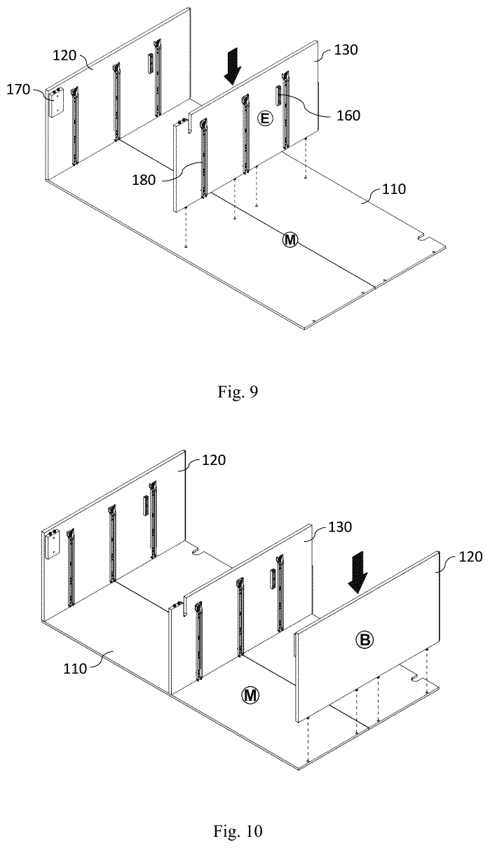

FIG. 9 illustrates an exemplary of the centre panel 130 attaching onto the rear panel 110. Preferably, a plurality of the attachment members provided on both side of the centre panel 130. The attachment members include the first attachment member 160 and the plurality of drawer sliding tracks 180. Preferably, the centre panel 130 is attached to the rear panel 110 via the first fastening mechanism in a similar manner to the side panels 120.

FIG. 10 illustrates an exemplary of a second side panel 120 attaching onto the rear panel 110. Similar to the first side panel 120, one side of the second side panel 120 is provided with the same attachment members and the second side panel 120 is also attached to the rear panel 110 via the first fastening mechanism in the same manner.

Depending on the weight of the attachment members, the side panels 120 and/or the centre panel 130, the first fastening mechanism may not be sufficiently strong to hold the panels 120, 130 in an upright orientation. To address this issue, one or more first supporting members 161, as shown in FIG. 11, are provided to attach between the side panels 120 and the centre panel 130 so that the panels 120, 130 can maintain their orientation for the installation of the next panel. Preferably, the first supporting members 161 are attached to the assembly via a third fastening mechanism. The third fastening mechanism includes the at least one first attachment member 160 attached to the side panels 120 and the centre panel 130, and a tongue profile 162 extended from the first supporting panels 161.

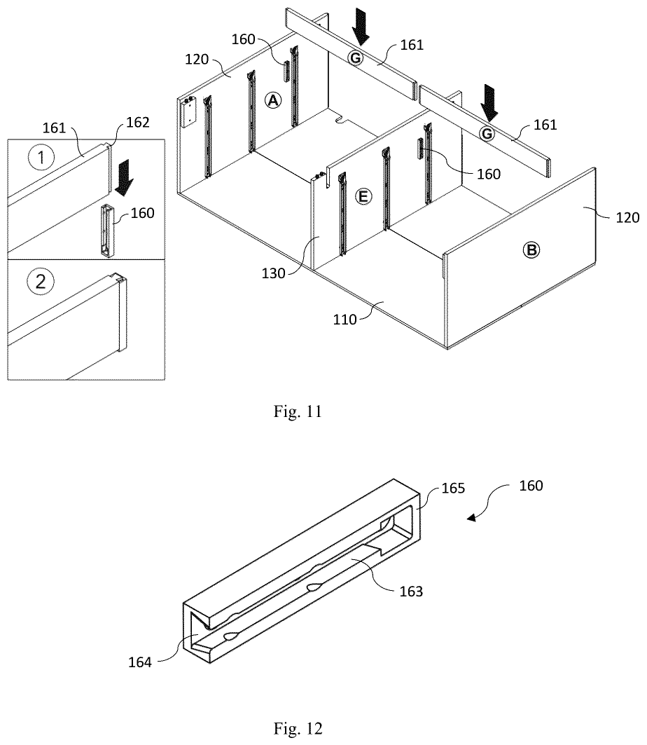

FIG. 12 illustrates an example of the first attachment member 160. Preferably, the first attachment member 160 includes a groove profile 163 that is complementary to the tongue profile 162 of the first supporting panels 161, so that the tongue profile 162 can engage with and be slidably inserted into the complementary groove profile 163. The groove profile 163 can be provided with an opening 164 for receiving the tongue profile 162 into its channel and a closed end 165 for preventing the first supporting panels 161 from overextending while the tongue profile 162 is sliding within the groove profile 163. Preferably, the groove profile 163 is of a length that is similar to or about the same as the width of the first supporting panels 161, so that the tongue profile 162 of the first supporting panels 161 can be entirely inserted into the first attachment members 160. Bulges or tabs (not shown) can be provided within the groove profile 163 to secure the first supporting panels 161 in the first attachment members 160.

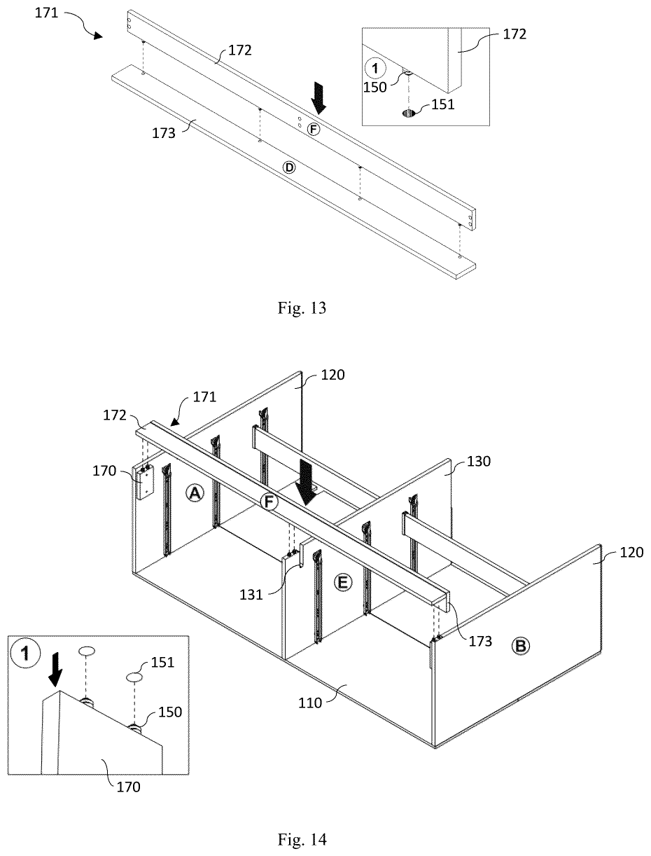

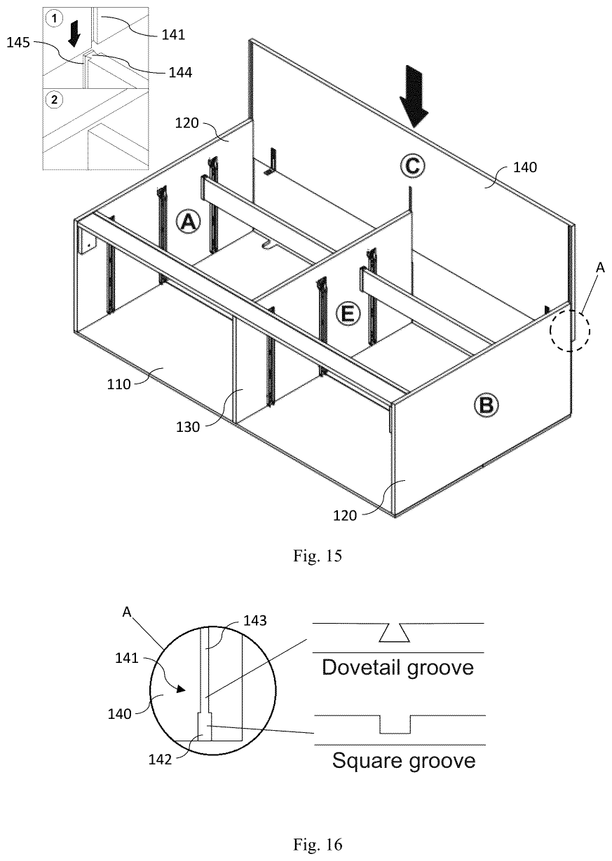

FIG. 13 illustrates an exemplary of the second supporting member 171. Preferably, the second supporting members 171 are formed by two elongate panel bodies 172, 173 that are connected together on their respective longitudinal edges via the first fastening mechanism. When assembled, the second supporting member 171 is of an inverted L-shape when view from the side. As shown in FIG. 14, the first panel body 173 of the second supporting member 171 can be inserted into a recess 131 on the centre panel 130 and supported by the second attachment members 170. The second panel body 172 of the second supporting member 171 can be provided with a plurality pinholes 151 for receiving pins 150 that extend from the second attachment members 170 and the centre panel 130. The inclusion of the second supporting member 171 not only strengthens the overall structure of the furniture assembly 100 but also adds to its visual appeal, particularly in its lower portion. In one specific embodiment, the pair of side panels 120 and/or the centre panel 130 each having a first edge with the plurality of pins 150 of the first fastening mechanism configured to engage and insert into the pinholes 151 of the rear panel 110, a second edge, adjacent to the first edge, with the projecting tongue profile 144 of the second fastening mechanism, and a third edge, opposing to the first edge, with the plurality of pins 150 of the first fastening mechanism for engaging with the pinholes 151 of the second supporting member 171.

FIG. 15 illustrates an exemplary of the top panel 140 attaching to the assembly. Preferably, the top panel 140 is attached to the assembly via the second fastening mechanism. Specifically, the second fastening mechanism includes one or more groove channels 141 on the top panels 140 and one or more projecting tongue profiles 144 extended from the side panels 120 and the centre panel 130 to engage with, and being inserted in, the complementary groove channels 141 via a sliding movement. Preferably, two side groove channels 141 are provided at positions adjacent to the edges of the top panel 140, and one centre groove channel 141 is provided at the centre position. This allows for the alignment of the groove channels 141 with the side panels 120 and the centre panel 130. Alternatively, the projecting tongue profile 144 of the centre panel 130 is shorter than those at the side panels 120. This ensures that when the projecting tongue profiles 144 of the side panels 120 initially engage with their corresponding groove channels 141 on the top panel 140, there will still be a gap or distance for the projecting tongue profile 144 of the centre panel to reach its corresponding groove channel 141. This configuration reduces the precision required for the initial engagement between the projecting tongue profiles 144 and their corresponding groove channels 141, and therefore eases the installation of the top panel 140. In one embodiment, the panels are made of engineering panels such as medium-density fiberboard and particleboard. In this embodiment, the projecting tongue profiles 144 are structurally enhanced by a layer of edging 145.

Preferably, at least one of the groove channels 141 can be provided with two groove profiles, as shown in FIG. 16. For instance, the groove channel 141 comprises a first section 142 and a second section 143. The first section 142 has a wider cross-sectional area compared to the second section 143. The first section 142 is configured to initially accommodate one portion of the projecting tongue profile 144 with a wider range of insertion angles than the second section 143. Subsequently, the first section 142 guides the projecting tongue profile 144 to slide towards the second section 143 in a predetermined orientation. By way of example, the projecting tongue profile 144 has a dovetail tongue configuration, the second section 143 is a dovetail groove configuration that is complimentary to the dovetail tongue configuration, and the first second 142 is a square groove configuration. Such configuration ensures smooth and effortless insertion of the main panels 110, 120, 130, 140, thereby reducing the risk of damage during the initial engagement of the second fastening mechanism's components. Up to this stage, the furniture assembly 100 remains entirely in a laying position during the assembly of the main panels 110, 120, 130, 140.

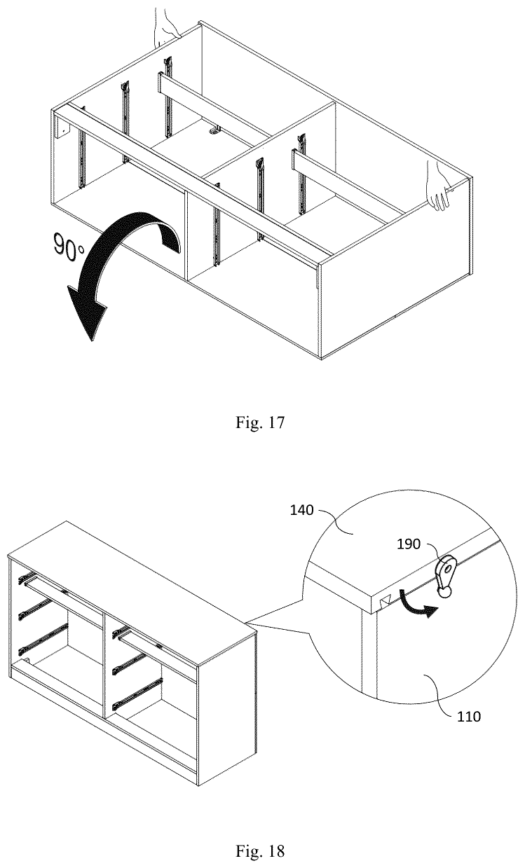

FIGS. 17 & 18 illustrates the reorientation of the assembly after the attachment of the top panel 140 to an operational configuration from the laying position, and a stopper member 190 for preventing the top panels 140 from overextending while sliding. When the assembly is in its operational configuration, it is also ready to receive the drawers units 200. Preferably, the stopper member 190 is rotatably hinged on the rear panel 110 and is rotatable to a lock configuration where the stopper member 190 blocks a sliding pathway of the top panel 140.

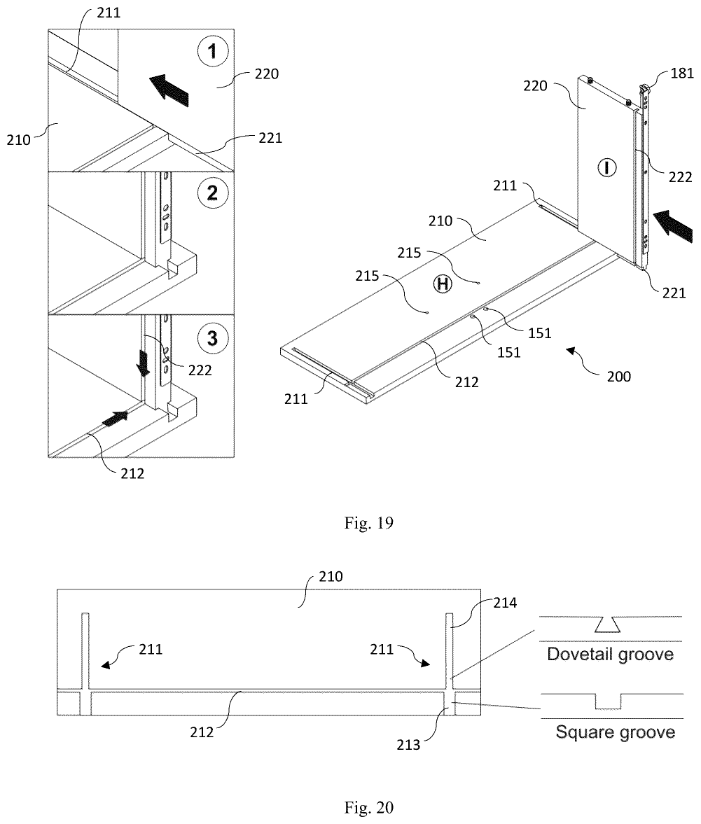

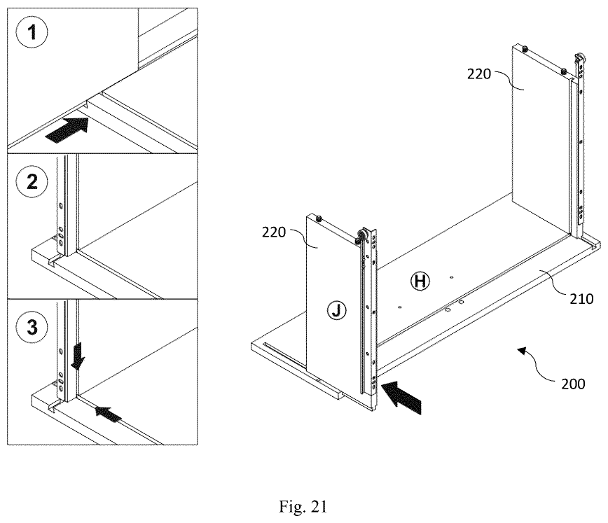

Referring to FIGS. 19 to 24, a process of assemble the drawer units 200 are illustrated. It should be noted that the first and second fastening mechanisms can also be employed at the drawer panels 210, 220, 240, 250. In a broader aspect of the invention, the furniture assembly can be a drawer unit 200. Preferably, the drawer panels 210, 220, 240, 250 include a front drawer panel 210, a pair of side drawer panels 220, a base drawer panel 240, and a rear drawer panel 250. Each of the side drawer panels 220 can be further attached with a drawer slide roller 181 that is engageable to the drawer sliding track 180. The front drawer panel 210 may be installed with a door pull.

FIGS. 19 & 21 shows an exemplary of the pair of side drawer panels 220

attaching to the front drawer panel 210 via the second fastening mechanism. Specifically, the second fastening mechanism includes a pair of groove channels 211 each positioned at one edge of the front drawer panel 210, and a projecting tongue profile 221 on an edge of each side drawer panel 220. As shown in FIG. 20, each groove channel 211 of the front drawer panel 210 is provided with two profiles as discussed in FIG. 16. For instance, the groove channel 211 of the front drawer panel 210 comprises a first section 213 and a second section 214. The first section 213 has a wider cross-sectional area compared to the second section 214. The first section 213 is configured to initially accommodate one portion of the projecting tongue profile 221 with a wider range of insertion angles than the second section 214. Subsequently, the first section 213 guides the projecting tongue profile 221 to slide towards the second section 214 in a predetermined orientation. By way of example, the projecting tongue profile 221 has a dovetail tongue configuration, the second section 214 is a dovetail groove configuration that is complimentary to the dovetail tongue configuration, and the first second 213 is a square groove configuration.

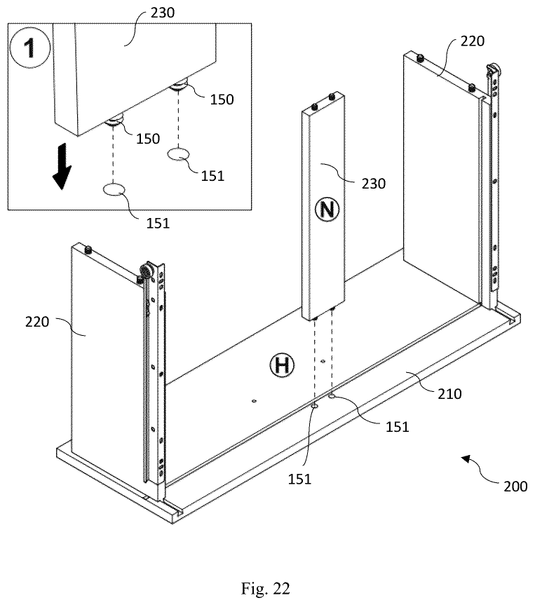

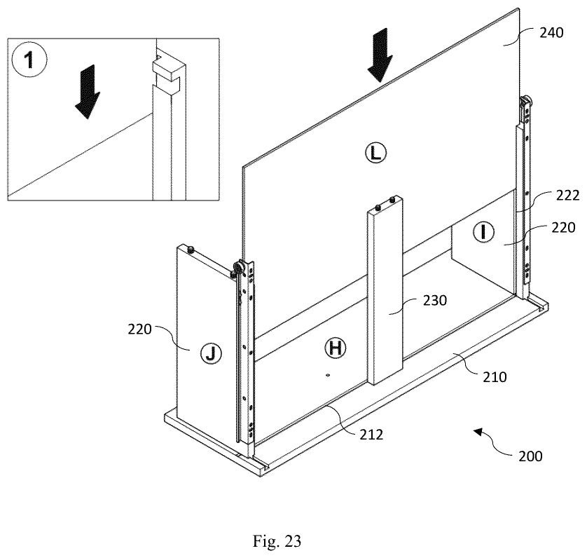

FIG. 22 illustrates an exemplary of a drawer supporting panel 230 attaching to the front drawer panel 210. Preferably, the drawer supporting panel 230 is attached to the front drawer panel 210 via the first fastening mechanism. Specifically, the first fastening mechanism includes a plurality of pins 150 extended from an edge of the drawer supporting panel 230, and a plurality of pinholes 151 on the front drawer panels 210. Alternatively, the pinholes 151 are located at the centre position of the front drawer panels 210 so that the drawer supporting panel 230 can be attached to the centre portion of the front drawer panel 210.

FIG. 23 illustrates an exemplary of the base drawer panel 240 attaching to the assembly. Preferably, edges of the base drawer panel 240 are slidably inserted to a groove 212, 222 on the side drawer panels 220 and the front drawer panel 210.

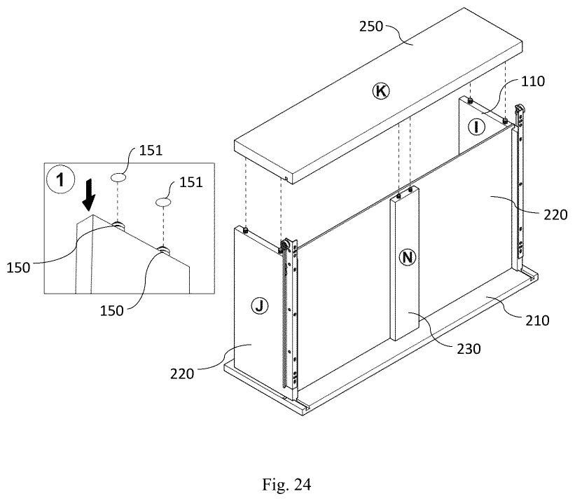

FIG. 24 illustrates an exemplary example of the rear drawer panel 250 attaching to the assembly and thereby completing the assembly of the drawer unit 200. Preferably, the rear drawer panel 250 is attached to the assembly via the first fastening mechanism. Specifically, the fastening mechanism includes a plurality of pinholes 151 on the rear drawer panel 250 and a plurality of pins 150 extended from the side drawer panels 220 and the drawer supporting panel 230. Upon completion of the assembly of the drawer unit 200, the drawer unit 200 can then be inserted into the furniture assembly via the drawer sliding tracks 180.

An objective of the invention is to provide a furniture assembly 100 that enables users to assemble the entire furniture 100 without the need for external tools such as a screwdriver. To achieve this, all the attachment members as discussed in above can be pre-attached to their designated panels, the pins 150 can be pre-installed, and the pinholes 151 can be pre-fabricated.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A furniture assembly comprising:
a plurality of main panels interconnected to each other via a first fastening mechanism and a second fastening mechanism;
wherein the first fastening mechanism includes one or more pinholes on at least one of the main panels and one or more pins extended from at least one of the main panels to engage with, and being inserted in, the complementary pinholes;
wherein the second fastening mechanism includes one or more groove channels on at least one of the main panels and one or more projecting tongue profiles extended from at least one of the main panels to engage with, and being inserted in, the complementary groove channels; and
wherein the furniture assembly remains entirely in a laying position during the assembly of the main panels.

2. The furniture assembly according to claim 1, wherein the main panels include:
a rear panel having a plurality of pinholes of the first fastening mechanism;
a pair of side panels, each having a first edge with a plurality of pins of the first fastening mechanism configured to engage and insert into the pinholes of the rear panel, and a second edge, adjacent to the first edge, with a projecting tongue profile of the second fastening mechanism;
a top panel having a plurality of groove channels of the second fastening mechanism configured to engage and slidably receive the projecting tongue profiles of the side panels.

3. The furniture assembly according to claim 2, wherein each side panel further comprises a third edge, opposing to the first edge, with a plurality of pins of the first fastening mechanism, and a second supporting members having a plurality of pinholes of the first fastening mechanism configured to engage and receive the pins on the third edge of the side panels.

4. The furniture assembly according to claim 2, wherein the rear panel is a foldable panel, whereby the foldable panel comprises a pair of board bodies hinged by a flexible strip, allowing the board bodies to flap between a folded configuration and an expanded configuration.

5. The furniture assembly according to claim 2, wherein the main panels further include a centre panel with the same configuration as the side panels.

6. The furniture assembly according to claim 1, wherein at least one groove channel of the second fastening mechanism includes a first section and a second section, whereby the first section, has a cross-sectional area wider than the second section, is configured to initially receive one portion of the projecting tongue profile with a wider tolerance of insertion angles than the second section and to subsequently guide the projecting tongue profile to slide towards the second section at a designated orientation.

7. The furniture assembly according to claim 6, wherein at least one of the projecting tongue profile has a dovetail tongue configuration, the second section is a dovetail groove configuration that are complimentary to the dovetail tongue configuration, and the first second is a square groove configuration.

8. The furniture assembly according to claim 1, wherein each pin of the first fastening mechanism includes a first portion and a second portion, both of which have serrated circular protrusions, the diameter of the serrated circular protrusions on the first portion is larger than those on the second portion.

9. The furniture assembly according to claim 1, further comprising a third fastening mechanism for attachment of at least one first supporting panel to the main panels, whereby the third fastening mechanism includes at least one first attachment member attached to at least one of the main panels, and a tongue profile extended from the at least one first supporting panel, the first attachment member includes a groove profile that is complementary to the tongue profile so that the tongue profile can engage with and being inserted into the complementary groove profile.

10. The furniture assembly according to claim 9, wherein the groove profile includes a closed end for preventing the first supporting panel from overextending while the tongue profile is sliding within the groove profile.
